(19) United States
(12) Patent Application Publication
(10) Pub. No.: US 2006/0273605 A1
(43) Pub. Date: Dec. 7, 2006

(54) Stowage device for a vehicle luggage space

(76) Inventors: Klaus Haspel, Rottenburg (DE); Dirk Gass, Weil der Stadt (DE)

Correspondence Address: FLYNN THIEL BOUTELL & TANIS, P.C., 2026 RAMBLING ROAD, KALAMAZOO, MI, 49008-1631, US

(21) Appl. No.: 11/444,898

(22) Filed: Jun. 1, 2006

(30) Foreign Application Priority Data
Jun. 1, 2005 (DE) 102005026671.1

(51) Int. Cl. B62D 25/20; B62D 33/03

(52) U.S. Cl. 296/26.09

(57) ABSTRACT

A stowage device for a vehicle luggage space. A stowage device for a vehicle luggage space having longitudinal guides on the vehicle in the region of an upper side of the vehicle luggage space, a drawer part being guided in said longitudinal guides in a longitudinally displaceable fashion, is known. According to the invention, the longitudinal guides comprise telescopically extendable guide rails to which the drawer part is fastened, the guide rails being mounted in an extendable manner by means of rolling bearings which are free of play. Use for passenger vehicles.

The invention relates to a stowage device for a vehicle luggage space having longitudinal guides on the vehicle in the region of an upper side of the vehicle luggage space, a drawer part being guided in said longitudinal guides in a longitudinally displaceable fashion.

A stowage device of said type is known from DE 101 12 272 A1. The known stowage device comprises a drawer part which is mounted in guides in the luggage space such that it can be displaced between a rest position and a receiving position. The guides in the luggage space are embodied, in an upper region of the luggage space, as C-shaped guide sections and are fastened to luggage space side walls or to an upper top wall of the luggage space, which is also denoted as a rear parcel shelf.

It is an object of the invention to produce a stowage device of the type mentioned in the introduction which is convenient to operate and can be accommodated in the luggage space in a space-saving and unobtrusive manner.

Said object is achieved in that the longitudinal guides comprise telescopically extendable guide rail arrangements to which the drawer part is fastened, the guide rail arrangements being mounted in an extendable manner by means of rolling bearings which are free of play. The telescopically extendable guide rail arrangements permit a relatively long pull-out travel, so that, in its rest position, the drawer part can be accommodated in a space-saving manner directly below a top wall of the luggage space and yet can be pulled out toward the operator into a convenient pulled-out position, in which the drawer part is freely accessible from above, for removing or stowing corresponding objects. The solution according to the invention is particularly suitable for vehicle luggage spaces in notchback vehicles in which a luggage space extends under a bodyshell part which forms an upper-side top wall and is also denoted as a rear parcel shelf. In the same way, it is however also possible to provide a drawer part of said type in fastback or hatchback vehicles, in which an upper, dimensionally stable cover of the luggage space is formed at approximately the level of a vehicle sill edge by a moveable plate part or shell part. The rolling bearings which are free of play permit the drawer part to be conveniently pulled out or pushed in with little expenditure of energy and additionally permit rattle-free seating of the drawer part. By virtue of the fact that the drawer part is fastened to the extendable guide rails, those guide sections of the guide rails which are fixed with respect to the luggage space can be attached to a corresponding top wall in a rear region of the luggage space such that they are largely hidden. The drawer part can, however, be pulled out into an ergonomically favorable loading or unloading position which corresponds to the receiving position.

In one embodiment of the invention, end stops are provided both for a pulled-out functional position and also for a pushed-in rest position. The end stops prevent the drawer part from being pulled out so far forward that the different rail parts of the guide rails become detached from one another or are damaged. In addition, this provides the operator with a defined pulled-out position.

In a further embodiment of the invention, a locking device, which secures the drawer part in the rest position with limited force, is provided for the pushed-in rest position, the securing force being selected such that the drawer part remains in its rest position during normal driving situations and can be pulled out into the functional position under manual tensile load. The securement with limited force by means of the locking device ensures on the one hand that the drawer part is secured in its rest position while the motor vehicle is being driven, in particular during instances of acceleration, deceleration or lateral acceleration as a result of cornering. The securement is however advantageously limited in terms of force in such a way that an operator can move the drawer part from the rest position into the pulled-out position without having to perform an unlocking process first.

In a further embodiment of the invention, the securing force is applied by a spring force of a latching spring.

In a further embodiment of the invention, the locking device comprises a latching catch and a corresponding latching recess which are respectively arranged on the vehicle and on the drawer, and the latching catch or the latching recess are arranged such that they are flexibly spring-loaded by means of the latching spring. The latching arrangement formed by the at least one latching catch and the at least one latching recess acts in a positive-locking manner in the pulling-out or pushing-in direction, but preferably has run-on slopes in both directions which make it possible both to push the drawer part into the rest position and to pull it out of the rest position with approximately the same manual expenditure of energy.

In a further embodiment of the invention, the rolling bearings are embodied as ball bearing cage guides. This provides a particularly high-quality rolling bearing which is free of play both along the guide rails and also transversely with respect to the guide rails. Provision is preferably made—as viewed in cross-section—of upper and lower rows of ball bearings, said rows preferably being arranged in such a way that they are positioned in the corners of an imaginary quadrangle. The guide rail parts are embodied such that they respectively bear against the corresponding rows of ball bearings at the outside and at the inside. The guide rail parts are preferably made from metal, in particular steel or a light metal alloy, and are preferably of an extremely deformation-resistant design.

Further advantages and features of the invention will emerge from the claims and from the following description of a preferred exemplary embodiment of the invention which is illustrated with reference to the drawings.

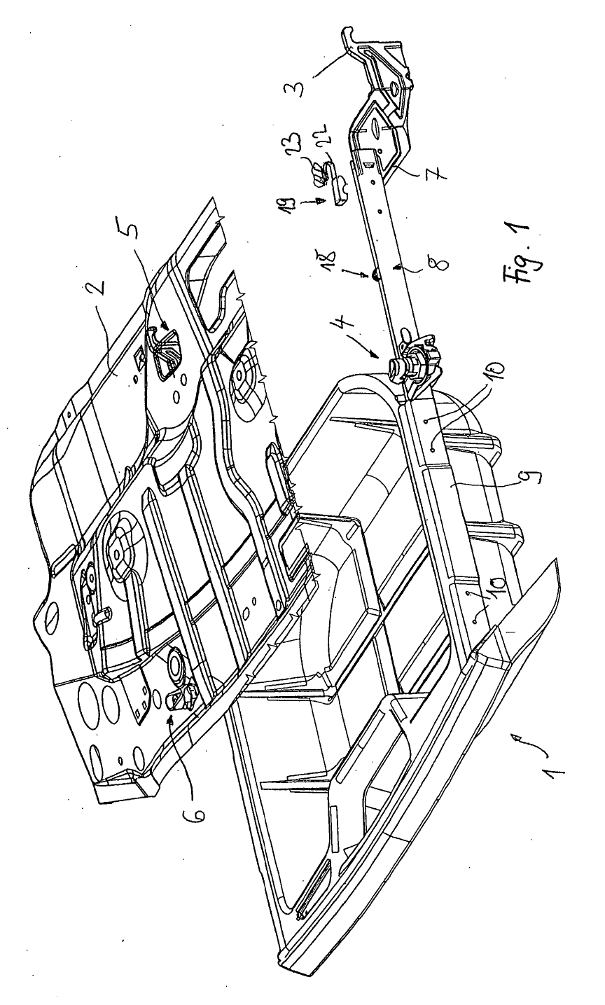

FIG. 1 is a perspective illustration of an embodiment of a stowage device according to the invention,

FIG. 2 is a perspective illustration of a guide rail arrangement for a drawer part of the stowage device from FIG. 1,

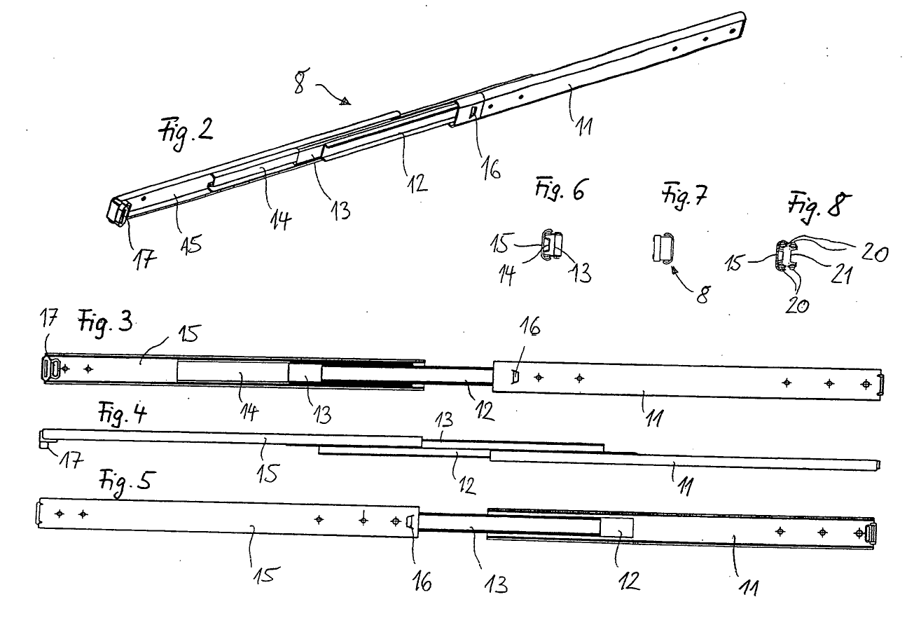

FIG. 3 shows the guide rail arrangement from FIG. 2 in a first view,

FIG. 4 shows a view of the guide rail arrangement from FIG. 3 rotated through 90°,

FIG. 5 shows a view of the guide rail arrangement from FIG. 4 rotated through 90°,

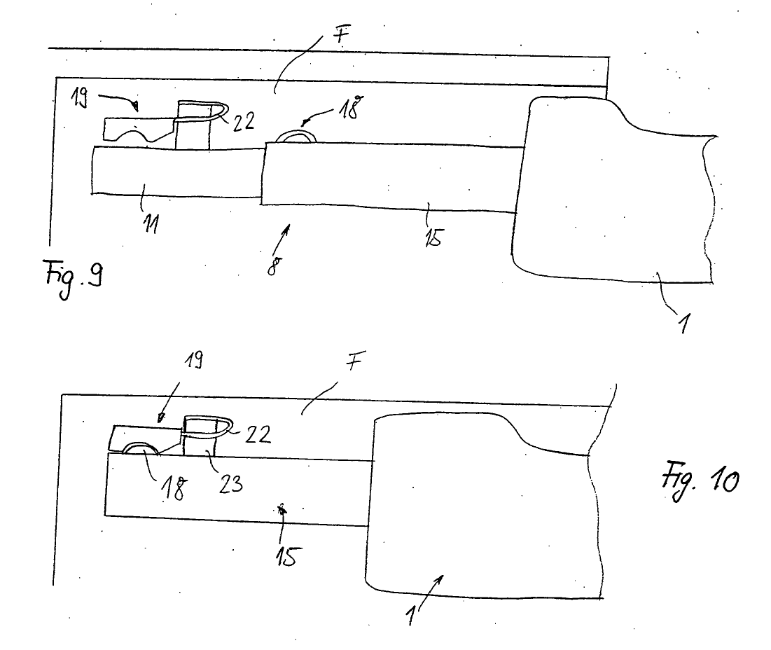

FIGS. 6 to 8 are various sectioned illustrations of the guide rail arrangement from FIG. 2 and

FIGS. 9 and 10 are schematic illustrations of a detail of a stowage device similar to FIG. 1 having a locking device for securing the drawer part in its rest position with limited force.

A stowage device according to FIG. 1 has a drawer part 1 which is embodied as a plastic tray and is arranged, by means of longitudinal guides 8 arranged in the luggage space, within a luggage space (not illustrated in any more detail) of a motor vehicle, below a rear parcel shelf 2 which serves as a top wall and is formed by a bodyshell part. The longitudinal guides 8 flank the drawer part 1 at opposite sides and are anchored, such that they are aligned approximately horizontally and in the vehicle longitudinal direction, on the lower side of the rear parcel shelf 2 by means of fastening elements 3, 4. Each longitudinal guide 8 has a guide rail arrangement 11 to 15 (FIGS. 2 to 5). One rail part of each guide rail arrangement, said rail part being fixed with respect to the luggage space, is fastened to a support part 7 on which a rear fastening element 3 is integrally formed. The associated front fastening element 4 is also arranged on the support part 7. One of the end rail parts 11, 15 of the guide rail arrangement 8 is fastened by means of screws to that support part 7 which, in a corresponding mirror-symmetric embodiment, is provided on the opposite side of the drawer part 1. The guide rail arrangement 8, which in each case flanks a respective longitudinal side of the drawer part 1 as viewed in the pulling-out direction, is constructed from deformation-resistant metal sections. In addition to the end rail part, which is fixed with respect to the vehicle, each guide rail arrangement 8 has rail sections 12, 13, 14, 15 which can be pulled out telescopically with respect to said end rail part, the respective other end rail part 15 being fastened by fastening means 10 to a side edge of the drawer part 1 (FIG. 1).

The basic design of the guide rail arrangements 8 is similar or identical to that of high-quality drawer guides, as are known from the furniture industry. As can be seen from FIGS. 6 to 8, each guide rail arrangement 8 is provided with rolling bearings which are embodied as ball bearing cage guides, provide bearing which is completely free of play and allow the rail parts 11 to 15 to be displaced relative to one another telescopically. Further details of the guide rail arrangement 8 can be gathered from the drawings, in particular FIGS. 2 to 8. The two profiled rail parts 12, 13 are preferably embodied as C-shaped profiled rails which are arranged mirror-symmetrically with respect to one another and are fastened to one another at their rear sides. The rigid connection between the rail parts 12 and 13 is formed in particular by means of a cohesive connection such as a weld or the like.

The end rail parts 11, 15 are provided with integrated end stops 16 in order to prevent the individual rail parts from being detached from one another. The reference symbol 17 denotes a damping element which, as it is embodied as a plastic part, avoids a metallic stop for the pushed-in rest position.

The rolling bearings are embodied as ball bearing cage guides, it being possible to see the design of the cage 21 and the arrangement of the rows of ball bearings 20 in FIG. 9.

FIG. 1 illustrates an at least partially pulled-out receiving or functional position of the drawer part 1. In said receiving or functional position, it is possible to load or unload the drawer part 1. In terms of its holding capacity, the drawer part 1 is limited to holding small parts. In the pushed-in rest position, the drawer part 1 is positioned entirely below the rear parcel shelf 2 and therefore does not project into a luggage space opening, which is closed or opened by means of a luggage space lid.

In order to keep the drawer part 1 in the rest position even while the motor vehicle is being driven, that is to say during instances of acceleration, deceleration or lateral acceleration during cornering, a locking device 18, 19 is provided for the rest position, said locking device 18, 19 ensuring that the drawer part 1 is secured in its rest position with limited force. The locking device has at least one latching profile pair 18, 19 which is associated with one of the two guide rail arrangements 8. It is also possible to assign a respective latching profile pair 18, 19 to each guide rail arrangement 8. In the embodiment illustrated, a rail part 15 which is moveable together with the drawer part 1 (FIGS. 1, 9 and 10) is assigned an upwardly projecting latching catch 18. A rail part 11 which is fixed with respect to the luggage space is assigned a plastic latching body 19 which has a latching recess which is provided with a run-on slope in the pushing-in direction of the drawer part 1. The plastic latching body 19 is suspended on a latching spring 22 which is held on a support part 23 which is fixed with respect to the vehicle and the luggage space. The latching spring 22 is formed in the illustrated embodiment by a curved plate spring, which allows the latching recess provided on the plastic body 19 to deflect elastically upward. The latching catch 18 is formed in the shape of a dome or arc. The latching recess of the plastic body 19 is correspondingly of concave or circular-arc-shaped form. The latching catch 18 is arranged at an upper side of the rail part 15. When the drawer part 1 is pushed in, the latching catch 18 slides on the run-on slope of the plastic body 19 and therefore along the latching recess and pushes the plastic body upward, counter to the spring force of the latching spring 22, until the latching catch 18 dips into the latching recess whose shape is matched to that of the latching catch 18 (FIG. 10). The plastic body, together with its latching recess, is pushed onto the latching catch 18 of the rail part 15 by the spring force of the latching spring 22, and holds the rail part 15 and therefore also the drawer part 1 in said position without play. The spring force of the latching spring is dimensioned such that when the drawer part 1 is pulled out again toward the corresponding operator in the direction of the luggage space opening, the latching catch can push the latching recess and therefore the plastic body upward, counter to the spring force of the latching spring 22. Here, the operator must exert such a pulling force, which they apply by gripping the drawer part 1 by hand, that the resistance formed by the latching profile pair 18, 19 is overcome. The latching spring 22 allows the plastic body to deflect upward, without the plastic body or the latching catch being damaged. After the drawer part 1 has been pulled out, the latching spring 22 automatically returns the plastic body to the unloaded initial position as per FIG. 9. When the drawer part 1 is pushed in again, the previously described locking process is repeated. The retaining forces which retain the drawer part 1 in the region of the latching arrangement 18, 19 are preferably no higher than a pulling-out force of 50 N, which the operator must apply when pulling the drawer part 1 out of its rest position in order to pull the drawer part out of the rest position and therefore out of the latched position.

1. A stowage device for a vehicle luggage space having longitudinal guides on the vehicle in the region of an upper side of the vehicle luggage space, a drawer part being guided in said longitudinal guides in a longitudinally displaceable fashion, wherein the longitudinal guides comprise telescopically extendable guide rail arrangements (8) to which the drawer part (1) is fastened, the guide rail arrangements (8) being mounted in an extendable manner by means of rolling bearings (20, 21) which are free of play.

2. The stowage device as claimed in claim 1, wherein end stops (16, 17) are provided both for a pulled-out functional position and also for a pushed-in rest position.

3. The stowage device as claimed in claim 1, wherein a locking device (18, 19, 22), which secures the drawer part (1) in the rest position with limited force, is provided for the pushed-in rest position, the securing force being selected such that the drawer part (1) remains in its rest position during normal driving situations and can be pulled out into the functional position under manual tensile load.

4. The stowage device as claimed in claim 3, wherein the securing force is applied by a spring force of a latching spring (22).

5. The stowage device as claimed in claim 3, wherein the locking device comprises at least one latching catch (18) and at least one corresponding latching recess (19) which are respectively arranged on the vehicle and on the drawer, and wherein the latching catch (18) or the latching recess (19) are arranged such that they are flexibly spring-loaded by means of the latching spring (22).

6. The stowage device as claimed in claim 1, wherein the rolling bearings are embodied as ball bearing cage guides.
